(19) United States
(12) Patent Application Publication
(10) Pub. No.: US 2026/0029334 A1
(43) Pub. Date: Jan. 29, 2026

(54) ANALYSIS APPARATUS

(71) Applicant: FUJIFILM CORPORATION, Tokyo (JP)

(72) Inventor: Yoshinobu MIURA, Tokyo (JP)

(21) Appl. No.: 19/269,064

(22) Filed: Jul. 15, 2025

(30) Foreign Application Priority Data
Jul. 23, 2024 (JP) 2024-117841

(51) Int. Cl. G01N 21/25; G01N 21/27; G01N 21/78

(52) U.S. Cl. CPC G01N 21/255; G01N 21/27; G01N 21/78

(57) ABSTRACT

An analysis apparatus includes: a support table that supports a wet-phase analysis chip having a flow passage in which a specimen sample and a reagent react or a flow passage that holds a reaction product; a light source unit for a wet phase that emits measurement light for transmission through the flow passage; and an area sensor facing the light source unit with the support table interposed therebetween and that captures an image showing a reaction state by receiving the measurement light, wherein the light source unit includes a first light-emitting element and a second light-emitting element that emit first measurement light and second measurement light having different wavelengths, respectively, in which an irradiation region of the first measurement light and an irradiation region of the second measurement light in the flow passage are within an imaging range of the area sensor and have different center positions.

### CROSS REFERENCE TO RELATED APPLICATIONS

This application claims priority from Japanese Application No. 2024-117841, filed on Jul. 23, 2024, the entire disclosure of which is incorporated herein by reference.

### BACKGROUND

### 1. Technical Field

The present disclosure relates to an analysis apparatus.

### 2. Related Art

An analysis apparatus that analyzes a specimen sample using an analysis chip on which a specimen sample such as blood is spotted is known. As one of such analysis apparatuses, an apparatus is known in which a specimen sample and a reagent are reacted with each other, and a coloration state thereof is optically detected, thereby performing quantitative analysis of a detection target substance contained in the specimen sample. The specimen sample is, for example, blood or urine. As the analysis chip, an analysis chip comprising a reagent layer containing a dry-phase reagent is generally used.

Meanwhile, the analysis apparatus may be configured to cause the specimen sample to flow, cause the specimen sample to react with the reagent in the flow passage, and optically detect the coloration state in the flow passage. JP2015-179038A proposes a measurement chip for detecting a coloration state in such a flow passage. In JP2015-179038A, the analysis apparatus comprises, in an irradiation source, a first light-emitting element and a second light-emitting element that emit light having different wavelengths. In the irradiation source, the first light-emitting element and the second light-emitting element are installed side by side. A light-receiving element is arranged at a position facing the irradiation source and is configured to receive the light transmitted through the analysis chip. Here, the first light-emitting element is used for detecting the coloration reaction, and the second light-emitting element is used for obtaining a correction value for correcting the measurement value of the coloration reaction.

### SUMMARY

In a case in which the detection of the coloration reaction by the first light-emitting element and the acquisition of the correction value by the second light-emitting element are sequentially performed, and the light-emitting elements are light-emitting diodes (LEDs), the light emission amount is not stable due to heat generation in a case in which the light-emitting elements are repeatedly turned on and off in a short time, and there is a possibility that a photometric value varies.

An object of the present disclosure is to provide an analysis apparatus capable of stabilizing a light emission amount of two light-emitting elements for detecting a coloration reaction and for acquiring a correction value and capable of performing quantitative analysis with higher accuracy.

The present disclosure relates to an analysis apparatus comprising: a support table that supports a wet-phase analysis chip having a flow passage that holds a mixed solution of a specimen sample and a reagent; a light source unit for a wet phase that emits measurement light for transmission to be transmitted through the flow passage of the wet-phase analysis chip; and an area sensor that is arranged to face the light source unit for a wet phase with the support table interposed therebetween and that captures an image showing a reaction state between the specimen sample and the reagent in the flow passage by receiving the measurement light for transmission, in which the light source unit for a wet phase includes a first light-emitting element and a second light-emitting element that emit first measurement light and second measurement light having different wavelengths, respectively, as the measurement light for transmission, in which an irradiation region of the first measurement light and an irradiation region of the second measurement light in the flow passage are present within an imaging range of the area sensor and have at least different center positions.

It is preferable that the first light-emitting element and the second light-emitting element are arranged at an interval in a direction along the flow passage.

It is preferable that, in a case in which a part of the irradiation region of the first measurement light and a part of the irradiation region of the second measurement light overlap each other, the first light-emitting element and the second light-emitting element are arranged at positions at which a fluctuation in a brightness value caused by the overlap of the irradiation regions in a case in which both the first light-emitting element and the second light-emitting element are turned on is 10% or less with respect to a brightness value of one irradiation region in a case in which only one of the first light-emitting element or the second light-emitting element is turned on.

It is preferable that the first measurement light is light having a wavelength in which transmittance in a case of transmission through the specimen sample changes depending on the reaction state, the second measurement light is light having a wavelength in which transmittance in a case of transmission through the specimen sample does not change even though the reaction state changes, the analysis apparatus further comprises a processor that performs quantitative analysis of a detection target substance based on the reaction state, and the processor acquires, as the image obtained by the area sensor, an image that includes the irradiation region of the first measurement light and the irradiation region of the second measurement light and that is captured in a state in which the first light-emitting element and the second light-emitting element are turned on, and corrects a first brightness value acquired from the irradiation region of the first measurement light in the image with a second brightness value acquired from the irradiation region of the second measurement light in the image.

The support table may be capable of supporting a dry-phase analysis chip having a reaction region that holds a dry-phase reagent, and it is preferable that the analysis apparatus further comprises a light source unit for a dry phase that is arranged on an area sensor side with respect to the support table and that emits measurement light for reflection to the reaction region of the dry-phase analysis chip supported by the support table.

It is preferable that the wet-phase analysis chip and the dry-phase analysis chip have a flat plate shape and have the same shape in plan view, the support table includes a plurality of cells on which any one of the wet-phase analysis chip or the dry-phase analysis chip is placed, the analysis apparatus further comprises a plurality of chip pressing sections that are respectively arranged to face the plurality of cells of the support table and each of which has a pressing surface for pressing the analysis chip placed on the cell, and the plurality of chip pressing sections have the same outer shape, in which the light source unit for a wet phase is arranged in at least one of the chip pressing sections and emits the first measurement light and the second measurement light from the pressing surface.

It is preferable that the analysis apparatus further comprises: a processor that controls the light source unit for a wet phase, the light source unit for a dry phase, and the area sensor, in which the processor executes control of performing imaging via the area sensor with the light source unit for a wet phase turned on for the wet-phase analysis chip, and performing imaging via the area sensor with the light source unit for a dry phase turned on for the dry-phase analysis chip.

It is preferable that the first measurement light is light having a wavelength in which transmittance in a case of transmission through the specimen sample changes depending on the reaction state in the flow passage, the second measurement light is light having a wavelength in which transmittance in a case of transmission through the specimen sample does not change depending on the reaction state in the flow passage, and the processor acquires, as the image obtained by the area sensor, an image that includes the irradiation region of the first measurement light and the irradiation region of the second measurement light, and that is captured in a state in which the first light-emitting element and the second light-emitting element are turned on, for the wet-phase analysis chip, corrects a first brightness value acquired from the irradiation region of the first measurement light in the image with a second brightness value acquired from the irradiation region of the second measurement light in the image, and performs quantitative analysis of a detection target substance.

With the analysis apparatus according to the present disclosure, it is possible to stabilize the light emission amount of the two light-emitting elements and to perform the quantitative analysis with higher accuracy.

### BRIEF DESCRIPTION OF THE DRAWINGS

FIG. 1 is a schematic configuration diagram showing an analysis apparatus according to a first embodiment.

FIG. 2 is a diagram showing a configuration of a wet-phase analysis chip.

FIGS. 3A and 3B are explanatory views showing a first irradiation region and a second irradiation region, respectively.

FIG. 4 is a schematic diagram showing an image P captured by an area sensor.

FIG. 5 is a schematic configuration diagram showing an analysis apparatus according to a second embodiment.

FIG. 6 is a plan view showing a main part of the analysis apparatus shown in FIG. 5.

FIG. 7 is a diagram showing a configuration of a dry-phase analysis chip.

FIG. 8 is a diagram showing a positional relationship between the dry-phase analysis chip and a photometry unit at a photometric position.

FIG. 9 is a diagram showing a positional relationship between the wet-phase analysis chip and the photometry unit at the photometric position.

### DESCRIPTION OF EMBODIMENTS

Hereinafter, preferred embodiments of the present disclosure will be described with reference to the accompanying drawings. In each of the drawings, the same reference numerals are given to the same components.

### First Embodiment

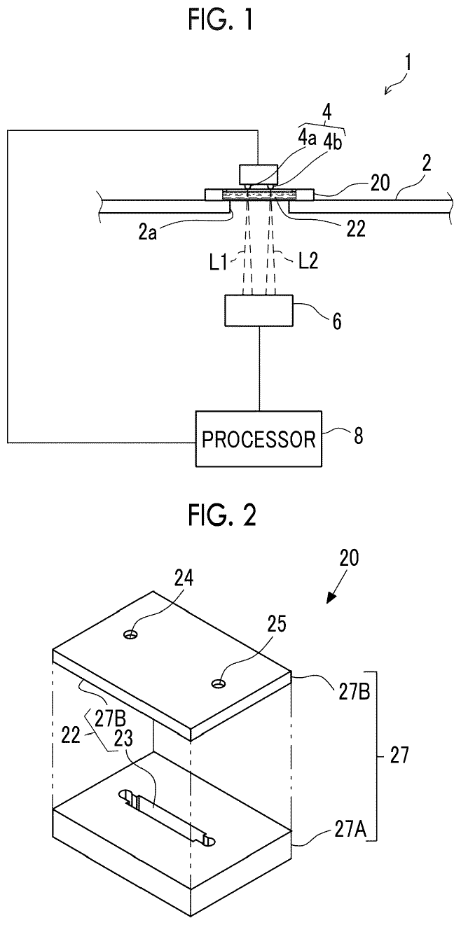

FIG. 1 is a diagram showing a schematic configuration of an analysis apparatus 1 according to a first embodiment. The analysis apparatus 1 quantifies a detection target substance contained in a specimen sample by using a wet-phase analysis chip 20. The analysis apparatus 1 measures a concentration of the detection target substance by colorimetric measurement. The specimen sample is, for example, plasma, whole blood, serum, or urine.

The wet-phase analysis chip 20 has a flow passage that holds a reaction product of the specimen sample and a reagent. Here, the “wet-phase analysis chip” refers to an analysis chip for mixing the specimen sample with a liquid reagent and analyzing the mixture as a solution, which is different from a dry-phase analysis chip described in a second embodiment later, and does not comprise a carrier that holds a dry-phase reagent. A mixed solution of the specimen sample and the reagent, which are mixed in advance in another vial, is supplied to the wet-phase analysis chip 20. However, the reagent may be supplied before and after the specimen sample is supplied to a flow passage 22, or the reagent may be supplied together with the specimen sample. Alternatively, a configuration may be adopted in which the reagent is accommodated in advance in the flow passage 22 of the wet-phase analysis chip 20 and the specimen sample is injected into the flow passage 22. The reagent reacts with the detection target substance in the specimen sample to generate a substance that develops a specific color, or aggregates to become turbid. Hereinafter, the substance that develops color or aggregates due to these reactions is referred to as the reaction product. The reagent used for the wet-phase analysis is, for example, a latex reagent containing latex particles that cause aggregation by reacting with the detection target substance.

FIG. 2 is an exploded perspective view showing the wet-phase analysis chip 20. In the wet-phase analysis chip 20, the flow passage 22 is enclosed in a case 27. The case 27 is composed of a case body 27A in which a recessed portion 23 is formed and a lid body 27B that is joined to the case body 27A so as to cover the recessed portion 23. The flow passage 22 is composed of the recessed portion 23 of the case body 27A and the lid body 27B that covers the recessed portion 23. The lid body 27B is provided with two openings 24 and 25 that communicate with the flow passage 22. The mixed solution of the specimen sample and the reagent is dispensed into the flow passage 22 from the opening 24 or the opening 25.

The analysis apparatus 1 comprises a support table 2, a light source unit for a wet phase 4, an area sensor 6, and a processor 8. The support table 2 supports the wet-phase analysis chip 20. The light source unit for a wet phase 4 emits measurement light for transmission to be transmitted through the flow passage 22, to the flow passage 22 of the wet-phase analysis chip 20. The area sensor 6 is arranged to face the light source unit for a wet phase 4 with the support table 2 interposed therebetween. The area sensor 6 receives the measurement light for transmission transmitted through the wet-phase analysis chip 20 to capture an image showing a reaction state between the specimen sample and the reagent in the flow passage 22. The area sensor 6 is, for example, an image sensor such as a charge-coupled device (CCD) camera and a complementary metal-oxide-semiconductor (CMOS) camera.

The light source unit for a wet phase 4 includes a first light-emitting element 4a and a second light-emitting element 4b that emit first measurement light L1 and second measurement light L2 having different wavelengths, respectively, as the measurement light for transmission. The first light-emitting element 4a and the second light-emitting element 4b are arranged at positions facing the flow passage 22 of the wet-phase analysis chip 20 placed on the support table 2. In a case in which the first light-emitting element 4a and the second light-emitting element 4b are turned on, an irradiation region E1 of the first measurement light L1 and an irradiation region E2 of the second measurement light L2 are present within an imaging range of the area sensor 6 in the flow passage 22 and have at least different center positions. As the light-emitting elements 4a and 4b, for example, a light-emitting diode (LED), organic electro luminescence (EL), and a semiconductor laser are used.

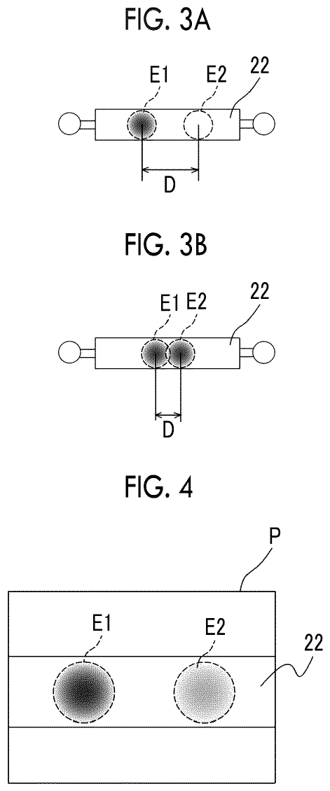

FIGS. 3A and 3B are diagrams schematically showing the irradiation region E1 of the first measurement light L1 (hereinafter, referred to as a first irradiation region E1) and the irradiation region E2 of the second measurement light L2 (hereinafter, referred to as a second irradiation region E2) in the flow passage 22. As shown in FIGS. 3A and 3B, the center position of the first irradiation region E1 and the center position of the second irradiation region E2 are different from each other. In the present example, the first irradiation region E1 and the second irradiation region E2 are arranged at an interval D in a direction along the flow passage 22, that is, in a direction in which the flow passage 22 extends.

It is preferable that the first irradiation region E1 and the second irradiation region E2 do not overlap each other as shown in FIG. 3A, but a part of the first irradiation region E1 and a part of the second irradiation region E2 may overlap each other as shown in FIG. 3B. As shown in FIG. 3B, in a case in which a part of the first irradiation region E1 and a part of the second irradiation region E2 overlap each other, the first light-emitting element 4a and the second light-emitting element 4b are arranged at positions at which a fluctuation in the brightness value caused by the overlap between the first irradiation region E1 and the second irradiation region E2 in a case in which both the first light-emitting element 4a and the second light-emitting element 4b are turned on is 10% or less, preferably 5% or less with respect to the brightness value of one irradiation region in a case in which only one of the first light-emitting element 4a or the second light-emitting element 4b is turned on. Specifically, the first light-emitting element 4a and the second light-emitting element 4b are arranged at an interval at which the brightness value of the first irradiation region E1 in a case in which only the second light-emitting element 4b is turned on is 10% or less, preferably 5% or less of the brightness value of the second irradiation region E2. Here, the brightness value of the irradiation region is an average value of brightness data in the irradiation region.

The first measurement light L1 is light having a wavelength in which the transmittance in a case of transmission through the specimen sample changes depending on the reaction state between the specimen sample and the reagent. That is, the first measurement light L1 is light having a wavelength in which the transmittance in a case of transmission through the mixed solution of the specimen sample and the reagent changes depending on the presence or absence of the reaction product generated by the reaction between the specimen sample and the reagent and the amount thereof. The first measurement light L1 is, for example, light including a wavelength absorbed by the reaction product. On the other hand, the second measurement light L2 is light having a wavelength in which the transmittance in a case of transmission through the specimen sample does not change even though the specimen sample and the reagent react with each other. That is, the second measurement light L2 is light having a wavelength in which the transmittance in a case of transmission through the mixed solution of the specimen sample and the reagent does not change depending on the presence or absence of the reaction product generated by the reaction between the specimen sample and the reagent and the amount thereof. In the analysis apparatus 1, the colorimetric measurement of the specimen sample can be performed by the first measurement light L1, and the correction value can be measured by the second measurement light L2.

The processor 8 comprehensively controls the respective units of the analysis apparatus 1. The processor 8 is configured by, for example, a central processing unit (CPU), and executes a program to execute measurement processing in the analysis apparatus 1. The processor 8 performs the quantitative analysis of the detection target substance based on the reaction state between the specimen sample and the reagent. The processor 8 optically detects the reaction state by the colorimetric measurement, and derives the concentration of the detection target substance based on a calibration curve showing a relationship between an optical density and the concentration of the detection target substance.

Processing of the quantitative analysis in the analysis apparatus 1 will be described.

First, the wet-phase analysis chip 20 in which the mixed solution of the specimen sample and the reagent mixed in advance in the vial is injected into the flow passage 22 is placed on the support table 2. The reaction product is contained in the mixed solution in which the detection target substance that reacts with the reagent is contained in the specimen sample, and a coloration reaction occurs.

In a state in which the wet-phase analysis chip 20 is placed on the support table 2, the processor 8 controls the light source unit for a wet phase 4 and the area sensor 6 to capture an image of the flow passage 22. Specifically, the processor 8 turns on the first light-emitting element 4a and the second light-emitting element 4b of the light source unit for a wet phase 4, and emits the first measurement light L1 and the second measurement light L2 to the flow passage 22. Then, the processor 8 causes the area sensor 6 to capture an image P (see FIG. 4) including the first irradiation region E1 irradiated with the first measurement light L1 and the second irradiation region E2 irradiated with the second measurement light L2 in the flow passage 22. The image P captured by the area sensor 6 is transmitted to the processor 8.

The processor 8 derives an average value of the brightness data of the first irradiation region E1 of the image P acquired from the area sensor 6, as a first brightness value. The brightness data may be data of the entire first irradiation region E1, or may be data obtained by extracting brightness data of a part of the first irradiation region E1, for example, a region of interest such as a central portion thereof. In addition, the processor 8 derives an average value of the brightness data of the second irradiation region E2 of the image P acquired from the area sensor 6, as a second brightness value. The brightness data in this case may be data of the entire second irradiation region E2, or brightness data of a part of the second irradiation region E2, for example, a region of interest such as a central portion thereof may be extracted.

The first brightness value reflects the reaction state between the specimen sample and the reagent. On the other hand, the second brightness value is a correction value reflecting a background that is irrelevant to the reaction state between the specimen sample and the reagent.

The processor 8 derives a corrected measurement value obtained by correcting the first brightness value with the second brightness value. For example, the corrected measurement value is derived as: corrected measurement value=first brightness value/second brightness value. The processor 8 derives the optical density from the corrected measurement value, and derives the concentration of the detection target substance based on the calibration curve showing the relationship between the optical density and the concentration of the detection target substance, which is stored in a memory (not shown) in advance. Here, “deriving the concentration of the detection target substance” means quantifying the detection target substance.

In this way, the quantitative analysis of the detection target substance is performed.

As described above, the analysis apparatus 1 of the present embodiment comprises the support table 2 that supports the wet-phase analysis chip 20 having the flow passage 22 that holds the mixed solution of the specimen sample and the reagent, the light source unit for a wet phase 4 that emits the measurement light for transmission to be transmitted through the flow passage 22 of the wet-phase analysis chip 20, and the area sensor 6 that is arranged to face the light source unit for a wet phase 4 with the support table 2 interposed therebetween and that captures the image P showing the reaction state between the specimen sample and the reagent in the flow passage 22 by receiving the measurement light for transmission. Then, the light source unit for a wet phase 4 includes the first light-emitting element 4a and the second light-emitting element 4b that emit the first measurement light L1 and the second measurement light L2 having different wavelengths, respectively, as the measurement light for transmission. In addition, the irradiation region E1 of the first measurement light L1 (here, the first irradiation region E1) and the irradiation region E2 of the second measurement light L2 (here, the second irradiation region E2) are present within the imaging range of the area sensor 6 in the flow passage 22 and have at least different center positions. With the above-described configuration, in a state in which the two irradiation regions E1 and E2 on the flow passage 22 of the wet-phase analysis chip 20 are irradiated with the measurement light L1 and L2 having different wavelengths, the area sensor 6 can capture a transmitted light image, and the two irradiation regions E1 and E2 can be imaged at the same time. In a case in which the two light-emitting elements 4a and 4b are turned on and off in sequence to acquire an image obtained with the first measurement light L1 and an image obtained with the second measurement light L2 at different timings, the light emission amount may not be stable due to heat generation or the like of the light-emitting elements 4a and 4b, and there is a possibility that a variation in the measurement value (brightness value) occurs. On the other hand, in the present embodiment, since both the first and second light-emitting elements 4a and 4b are turned on and the measurement value by the coloration reaction and the correction value can be acquired in a state in which the light emission amount is stabilized, the quantitative analysis with high accuracy can be performed.

The coloration reaction can be measured with the first measurement light L1, and the correction value can be measured with the second measurement light L2. By correcting the first brightness value derived from the brightness data of the first irradiation region E1 with the second brightness value derived from the brightness data of the second irradiation region E2, the measurement value that is not affected by the background can be obtained. In a case in which the specimen sample itself has a tint or turbidity component, the measurement of the coloration reaction with the first measurement light L1 includes background components such as the tint or turbidity component of the specimen sample, and the optical density becomes a falsely elevated value. As in the present embodiment, by measuring the correction value that is the background with the second measurement light L2, it is possible to derive the brightness value (optical density) substantially based on the coloration reaction, which is not affected by the tint or turbidity component of the specimen sample, and it is possible to perform the quantitative analysis with high accuracy. The “case in which the specimen sample itself has a tint or turbidity component” is specifically a case in which the specimen is hemolyzed or lipemic.

### Second Embodiment

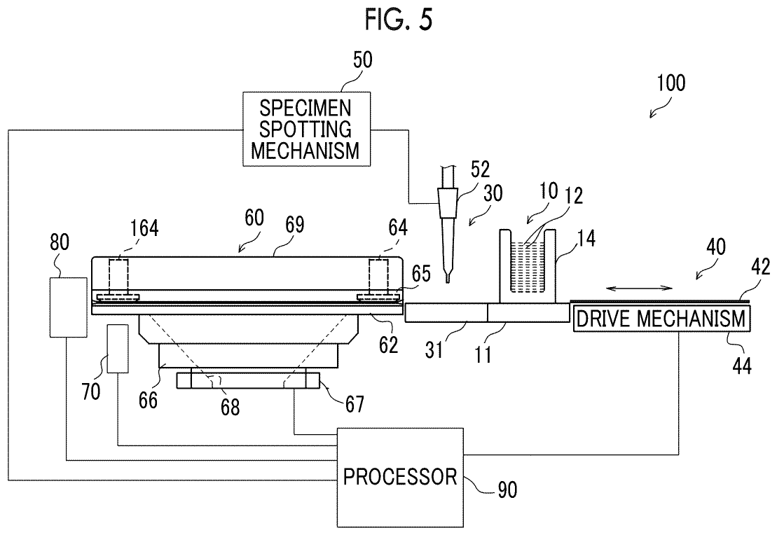

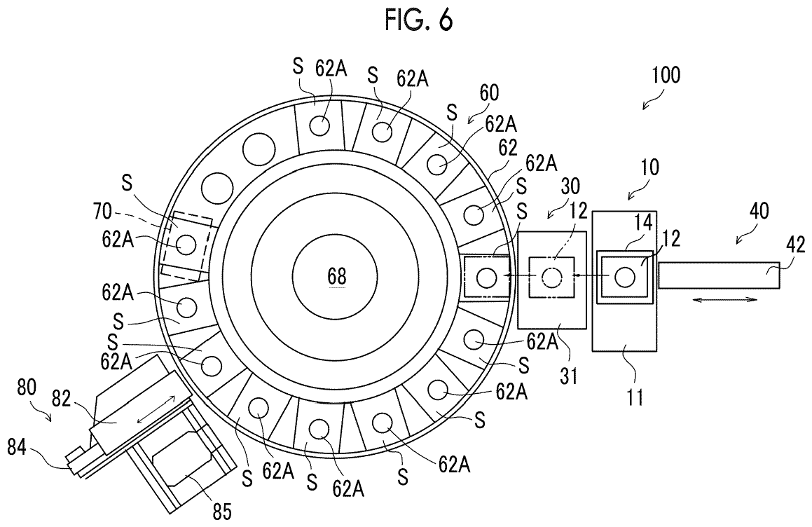

FIG. 5 shows a schematic configuration of an analysis apparatus 100 according to the second embodiment. FIG. 6 is a plan view showing a main part of the analysis apparatus 100 of FIG. 5. The analysis apparatus 1 according to the first embodiment described above is an apparatus that performs measurement using the wet-phase analysis chip 20, but the analysis apparatus 100 according to the second embodiment is an apparatus that can selectively measure the wet-phase analysis chip 20 and a dry-phase analysis chip 12. The wet-phase analysis chip 20 used for the analysis of this analysis apparatus 100 is the same as that of the analysis apparatus 100 according to the first embodiment, and thus the detailed description thereof will be omitted (see FIG. 2).

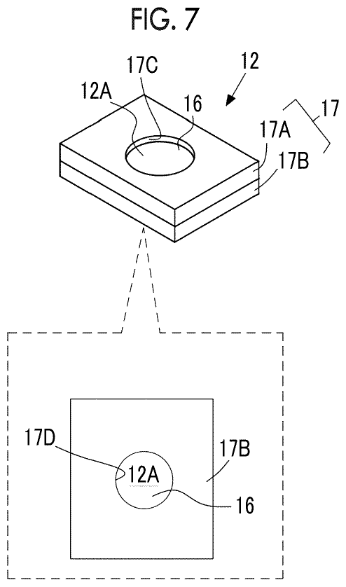

FIG. 7 shows a configuration example of the dry-phase analysis chip 12. The dry-phase analysis chip 12 has the same flat plate shape as the wet-phase analysis chip 20 described above, and has the same shape as the wet-phase analysis chip 20 in plan view. The dry-phase analysis chip 12 has a planar reaction region 12A in which the reagent is immobilized. The reagent reacts with the detection target substance to generate a substance that develops a specific color. The substance that develops color by this reaction is hereinafter referred to as a reaction product. As the reagent, for example, a dry-phase reagent that is in a dry state at least during shipment is used. The specimen sample is spotted onto the reaction region 12A of the dry-phase analysis chip 12. In addition, the same shape of the wet-phase analysis chip 20 and the dry-phase analysis chip 12 in plan view does not mean a perfect match, and the shapes in plan view may be substantially the same. In addition, the outer shapes of the dry-phase analysis chip 12 and the wet-phase analysis chip 20 may have any shape as long as the dry-phase analysis chip 12 and the wet-phase analysis chip 20 can be loaded into an incubator 60 described later and can be used for measurement, and are not limited to the shapes described in the present embodiment.

More specifically, the dry-phase analysis chip 12 has a carrier 16 including the reaction region 12A on which the specimen sample is spotted, and the carrier 16 is accommodated in a case 17. The case 17 is composed of a first case 17A and a second case 17B, and accommodates the carrier 16 such that the carrier 16 is sandwiched between the first case 17A and the second case 17B. An opening 17C that functions as a dropwise-addition port for spotting the specimen sample onto the reaction region 12A is formed in the first case 17A. An opening 17D for irradiating the reaction region 12A with light is formed in the second case 17B. The carrier 16 is exposed to the opening 17C of the first case 17A constituting a front surface of the dry-phase analysis chip 12. In addition, the carrier 16 is exposed to the opening 17D of the second case 17B constituting a back surface of the dry-phase analysis chip 12. A region exposed to the opening 17D of the carrier 16 constitutes the reaction region 12A in which the reagent is immobilized.

The analysis apparatus 100 comprises a chip set section 10, a specimen spotting section 30, a chip transport mechanism 40, a specimen spotting mechanism 50, an incubator 60, a photometry unit 70, a chip disposal mechanism 80, and a processor 90.

A stocker 14 that accommodates the dry-phase analysis chip 12 on a holding table 11 is arranged in the chip set section 10. A plurality of dry-phase analysis chips 12 are stacked and accommodated in the stocker 14.

The chip transport mechanism 40 transports the dry-phase analysis chip 12 from the chip set section 10 to the specimen spotting section 30, and further transports the dry-phase analysis chip 12 from the specimen spotting section 30 to the incubator 60. The chip transport mechanism 40 comprises a thin plate-shaped chip transport member 42 and a drive mechanism 44 that reciprocates the chip transport member 42 in a direction in which the chip set section 10, the specimen spotting section 30, and the incubator 60 are arranged. The drive mechanism 44 is, for example, a linear actuator. The chip transport member 42 is slidably supported by a guide rod (not shown) and is reciprocated by the drive mechanism 44. The chip transport member 42 is pressed against the dry-phase analysis chip 12 accommodated in the lowermost stage among the dry-phase analysis chips 12 stacked in the stocker 14. The dry-phase analysis chip 12 is transported to the incubator 60 side by moving the chip transport member 42 to the incubator 60 side in this state.

In the specimen spotting section 30, the specimen sample such as blood plasma, whole blood, serum, or urine is spotted onto the dry-phase analysis chip 12. The specimen spotting section 30 is provided with a chip support table 31, and the specimen sample spotting onto the dry-phase analysis chip 12 transported onto the chip support table 31 is performed on the chip support table 31. The specimen sample is spotted by the specimen spotting mechanism 50 described below. The chip support table 31 is arranged adjacent to the holding table 11.

As shown in FIG. 5, the specimen spotting mechanism 50 comprises a nozzle 52, a suction-and-discharge mechanism (not shown), and a moving mechanism that moves the nozzle 52. The specimen spotting mechanism 50 suctions the specimen sample from a specimen accommodation section (not shown) and spots the specimen sample onto the dry-phase analysis chip 12 in the specimen spotting section 30.

As in a case of the analysis apparatus 1, the wet-phase analysis chip 20 is placed on the chip support table 31 of the specimen spotting section 30 in a state in which the mixed solution of the specimen sample and the reagent mixed outside is injected into the flow passage 22, and is transported to the incubator 60 by the chip transport member 42. In addition, the analysis apparatus 100 may be separately provided with a stocker and a mixed solution dispensing mechanism for the wet-phase analysis chip 20.

The incubator 60 can accommodate a plurality of dry-phase analysis chips 12 and wet-phase analysis chips 20 inside. The incubator 60 has a constant temperature function of keeping a temperature constant in order to promote the reaction between the reagent and the specimen sample. A set temperature is, for example, 37° C.

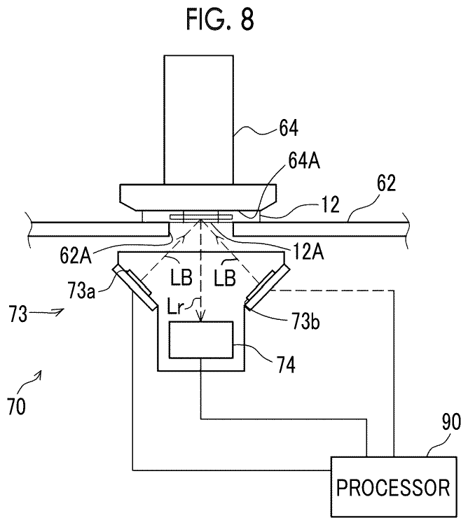

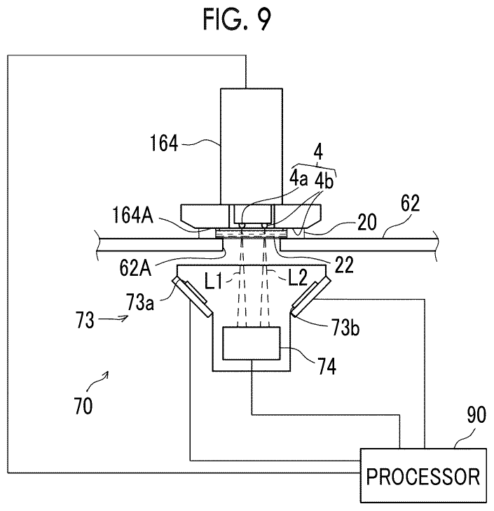

As shown in FIG. 6, the incubator 60 comprises an annular rotary substrate 62 on which a plurality of cells S in which the dry-phase analysis chip 12 or the wet-phase analysis chip 20 is loaded are provided. In addition, a disk-shaped holding member 65 is provided above the rotary substrate 62. The holding member 65 has a first chip pressing section 64 that presses the dry-phase analysis chip 12 loaded in the cell S toward the rotary substrate 62 from a direction facing the reaction region 12A. In addition, the holding member 65 has a second chip pressing section 164 that presses the wet-phase analysis chip 20 loaded in the cell S toward the rotary substrate 62 from a direction facing the reaction region 12A or the flow passage 22. One of the first chip pressing section 64 or the second chip pressing section 164 is arranged to face each of the plurality of cells S. As shown in FIG. 8, a slit-shaped space is formed between the pressing surface 64A of the first chip pressing section 64 and the cell S, and the dry-phase analysis chip 12 is loaded herein. Similarly, as shown in FIG. 9, a slit-shaped space is formed between the pressing surface 164A of the second chip pressing section 164 and the cell S, and the wet-phase analysis chip 20 is loaded herein. The rotary substrate 62 is an example of a “support table” according to the present disclosure that can support the wet-phase analysis chip 20 and the dry-phase analysis chip 12.

The first chip pressing section 64 and the second chip pressing section 164 have the same outer shape. However, the light source unit for a wet phase 4 is provided inside the second chip pressing section 164. The measurement light for transmission emitted from the light source unit for a wet phase 4 embedded in the second chip pressing section 164 is emitted from the pressing surface 164A of the second chip pressing section 164 toward the flow passage of the wet-phase analysis chip 20. A portion of the second chip pressing section 164 through which the measurement light for transmission passes is transparent (at least transmittance of 50% or more) to the measurement light for transmission. The light source unit for a wet phase 4 is the same as the light source unit for a wet phase 4 of the analysis apparatus 1 according to the first embodiment, and the relationship between the light source unit for a wet phase 4 and the wet-phase analysis chip 20 is also the same as in a case of the analysis apparatus 1, and thus the detailed description thereof will be omitted. Here, the first chip pressing section 64 and the second chip pressing section 164 having the same outer shape means that the first chip pressing section 64 and the second chip pressing section 164 may be interchangeable with each other, and it is allowed that the first chip pressing section 64 and the second chip pressing section 164 have different portions other than the components essential for the exchange.

A rotary cylinder 66 is provided below the rotary substrate 62. The rotary cylinder 66 has a substantially inverted triangular cross-sectional shape of which an inner diameter decreases downward. A bearing 67 is arranged below an outer periphery of the rotary cylinder 66, and the rotary cylinder 66 is rotatably supported by the bearing 67. The rotary substrate 62 rotates as the rotary cylinder 66 rotates. In addition, the holding member 65 rotates integrally with the rotary substrate 62. The rotary cylinder 66 has an opening at a bottom portion as a vertex portion of an inverted triangle, and this opening functions as a disposal hole 68 for disposing of the used dry-phase analysis chip 12 or the wet-phase analysis chip 20. The used dry-phase analysis chip 12 or wet-phase analysis chip 20 is moved to the center side of the annular rotary substrate 62 from a state of being loaded in the cell S, and is dropped toward an inclined surface of the rotary cylinder 66. The used dry-phase analysis chip 12 or wet-phase analysis chip 20 dropped into the rotary cylinder 66 slides on the inclined surface and is disposed of from the disposal hole 68.

A heating unit such as a heater (not shown) is arranged in the holding member 65, and the dry-phase analysis chip 12 and the wet-phase analysis chip 20 accommodated in the cell S are kept constant at a predetermined temperature by the temperature adjustment. A thermal insulation cover 69 is arranged on an upper surface of the holding member 65. It should be noted that FIG. 6 shows a state in which the holding member 65 and the thermal insulation cover 69 are removed and the rotary substrate 62 is exposed.

As shown in FIG. 6, an opening window 62A for photometry is formed at the center of the bottom surface of each cell S of the rotary substrate 62, and the colorimetric measurement of the dry-phase analysis chip 12 and the wet-phase analysis chip 20 is performed by the photometry unit 70 arranged below the rotary substrate 62 through the opening window 62A. A position at which the colorimetric measurement is performed by the photometry unit 70 is referred to as a photometric position.

The photometry unit 70 performs the colorimetric measurement, which is the measurement of optical density using a colorimetric method, on the dry-phase analysis chip 12. The photometry unit 70 is provided below the rotary substrate 62 in an outer peripheral portion of the incubator 60.

As shown in FIG. 8, the photometry unit 70 comprises a housing 71, a light source unit for a dry phase 73 that emits measurement light for reflection LB to the reaction region 12A, and an area sensor 74 that images the reaction region 12A. In the present example, the light source unit for a dry phase 73 comprises light-emitting elements 73a and 73b. In the present example, the light-emitting elements 73a and 73b have substantially the same central wavelength. Here, “substantially the same” means that the wavelengths match each other within a range of ±5 nm.

The wavelength of the measurement light for reflection LB is determined in accordance with the detection target substance. In the reaction region 12A to which the specimen sample is added dropwise, the reaction product that develops a specific color is generated by the reaction between the detection target substance and the reagent. The measurement light for reflection LB is light having a wavelength in which the reflection amount changes depending on the presence or absence of the reaction product and the amount thereof. The measurement light for reflection LB is, for example, light including a wavelength absorbed by the reaction product. In the present example, the configuration has been described in which the two light-emitting elements having substantially the same central wavelength are provided, but the light source unit for a dry phase 73 may comprise a plurality of light-emitting elements having different central wavelengths in order to emit the measurement light for reflection LB having different wavelengths depending on the detection target substance. As the light-emitting elements 73a and 73b, for example, a light-emitting diode (LED), organic electro luminescence (EL), or a semiconductor laser is used.

The area sensor 74 images a predetermined imaging range. In a case in which the dry-phase analysis chip 12 is located at the photometric position by the rotation of the rotary substrate 62, the region including the reaction region 12A irradiated with the measurement light for reflection LB emitted from the light-emitting elements 73a and 73b is imaged. In this case, the area sensor 74 acquires an image of reflected light Lr of the measurement light for reflection LB. In addition, in a case in which the wet-phase analysis chip 20 is located at the photometric position due to the rotation of the rotary substrate 62, the area sensor 74 images a region including the first irradiation region E1 and the second irradiation region E2 (refer to FIG. 4) irradiated with the measurement light for transmission emitted from the light source unit for a wet phase 4. In this case, the area sensor 74 acquires an image of transmitted light of the measurement light for transmission. The area sensor 74 is, for example, an image sensor such as a charge-coupled device (CCD) camera and a complementary metal-oxide-semiconductor (CMOS) camera. In this way, the area sensor 74 also has the same function as the area sensor 6 in the analysis apparatus 1.

The area sensor 74 outputs the captured image to the processor 90.

The housing 71 comprises an optical system (not shown) for collecting the reflected light Lr from the reaction region 12A or the first measurement light L1 and the second measurement light L2 transmitted through the flow passage 22, and guiding the reflected light Lr or the first measurement light L1 and the second measurement light L2 to the area sensor 74.

The processor 90 comprehensively controls the respective units of the analysis apparatus 100. The photometry unit 70 and the light source unit for a wet phase 4 are also controlled by the processor 90. The processor 90 is configured by, for example, a central processing unit (CPU), and executes a program to execute measurement processing in the analysis apparatus 100. The processor 90 performs the quantitative analysis of the detection target substance based on the reaction state between the specimen sample and the reagent. The processor 90 optically detects the reaction state by the colorimetric measurement of the reaction region 12A of the dry-phase analysis chip 12 and the flow passage 22 of the wet-phase analysis chip 20, and derives the concentration of the detection target substance based on the calibration curve showing the relationship between the optical density and the concentration of the detection target substance.

The quantitative analysis using the dry-phase analysis chip 12 is performed in a state in which the dry-phase analysis chip 12 is located at the photometric position by the rotation of the rotary substrate 62. In a state in which the dry-phase analysis chip 12 is located at the photometric position, the processor 90 turns on the light-emitting elements 73a and 73b of the light source unit for a dry phase 73. The processor 90 performs the imaging via the area sensor 74 in a state in which the light-emitting elements 73a and 73b are turned on and the reaction region 12A is irradiated with the measurement light for reflection LB. The processor 90 derives, as the measurement value, an average brightness value from the brightness data of the region of interest of the reaction region 12A in the image acquired from the area sensor 74. The processor 90 derives the optical density after correcting the measurement value as necessary. Then, the processor 90 derives the concentration of the detection target substance based on the calibration curve showing the relationship between the optical density and the concentration of the detection target substance, which is stored in the memory (not shown) in advance.

The quantitative analysis using the wet-phase analysis chip 20 is performed in a state in which the wet-phase analysis chip 20 is located at the photometric position by the rotation of the rotary substrate 62. In a state in which the wet-phase analysis chip 20 arranged at the photometric position is located, the processor 90 turns on the light-emitting elements 4a and 4b of the light source unit for a wet phase 4. The processor 90 performs imaging via area sensor 74 in a state in which the light-emitting elements 4a and 4b are turned on and the flow passage 22 is irradiated with the first measurement light L1 and the second measurement light L2, which are measurement light for transmission. The processing of the quantitative analysis using the wet-phase analysis chip 20 is the same as in a case according to the first embodiment, and the same effect can be obtained.

In addition, the memory stores a calibration curve for a dry-phase analysis chip and a calibration curve for a wet-phase analysis chip, and the processor 90 selects the calibration curve corresponding to the analysis chip to perform the quantitative analysis of the detection target substance.

As described above, the analysis apparatus 100 according to the second embodiment can perform the quantitative analysis using the dry-phase analysis chip 12 and the wet-phase analysis chip 20.

In the analysis apparatus 100, the first chip pressing section 64 is installed on the cell S for measuring the dry-phase analysis chip 12 among the plurality of cells S, and the second chip pressing section 164 comprising the light source unit for a wet phase 4 is installed on the cell S for measuring the wet-phase analysis chip 20. However, the second chip pressing section 164 may be installed on all the cells S. In a case in which the second chip pressing section 164 is installed on all the cells S, and the dry-phase analysis chip 12 is loaded in the cell S, the photometry is simply performed by the photometry unit 70 without using the light source unit for a wet phase 4. On the other hand, in a case in which the cell S for the wet-phase analysis chip 20 is set in advance, the second chip pressing section 164 comprising the light source unit for a wet phase 4 can be provided only for the cell S for the wet-phase analysis chip 20, and thus the cost can be suppressed as compared with a case in which the second chip pressing section 164 may be provided for all the cells S.

Since the first chip pressing section 64 and the second chip pressing section 164 have the same outer shape, the first chip pressing section 64 and the second chip pressing section 164 can be exchanged with each other as necessary. Therefore, the number of first chip pressing sections 64 and the number of second chip pressing sections 164 can be freely set in accordance with the usage aspect of a user of the analysis apparatus 100. For example, in a case in which 13 cells S are provided as shown in FIG. 6, a ratio between the first chip pressing section 64 and the second chip pressing section 164 can be set to 12:1 for a user having a low measurement frequency of the wet-phase analysis chip 20, and a ratio between the first chip pressing section 64 and the second chip pressing section 164 can be set to 10:3 for a user having a relatively high measurement frequency of the wet-phase analysis chip 20.

In the first and second embodiments described above, various processors shown below can be used as the hardware structures of the processors 8 and 90. The various processors include, in addition to a CPU that is a general-purpose processor that executes software (program) to function as various processing units, a programmable logic device (PLD) of which a circuit configuration can be changed after manufacturing, such as a field-programmable gate array (FPGA), and a dedicated electric circuit that is a processor having a circuit configuration dedicatedly designed for executing specific processing, such as an application specific integrated circuit (ASIC).

Furthermore, the processing described above may be executed by one of the various processors or may be executed by a combination of two or more processors (for example, a combination of a plurality of FPGAs or a CPU and an FPGA) of the same type or different types. Furthermore, a plurality of processing units may be configured by one processor. As an example in which the plurality of processing units are configured by one processor, there is a form in which a processor that realizes all functions of a system including the plurality of processing units by using one integrated circuit (IC) chip is used, such as a system on a chip (SOC).

Further, the hardware structure of these processors is, more specifically, an electric circuit (circuitry) in which the circuit elements, such as semiconductor elements, are combined.

In addition to the operation program of the analysis apparatus, the technology of the present disclosure extends to a computer readable storage medium (USB memory or digital versatile disc (DVD)-read only memory (ROM), or the like) that stores the operation program of the analysis apparatus in a non-transitory manner.

In addition, the above-described contents and the above-shown contents are for detailed description of the parts according to the technology of the present disclosure and are merely examples of the technology of the present disclosure. For example, the description of the configuration, the function, the operation, and the effect above are the description of examples of the configuration, the function, the operation, and the effect of the parts according to the technology of the present disclosure. As a result, it goes without saying that unnecessary parts may be deleted, new elements may be added, or replacements may be made with respect to the above-described contents and the above-shown contents within a range that does not deviate from the gist of the technology of the present disclosure. Moreover, in order to avoid complication and facilitate understanding of the parts according to the technology of the present disclosure, the description related to common technical knowledge or the like that does not need to be particularly described for enabling implementation of the technology of the present disclosure is omitted in the above-described contents and the above-shown contents.

All of the documents, the patent applications, and the technical standards described in the present specification are incorporated into the present specification by reference to the same extent as in a case in which each of the documents, the patent applications, and the technical standards are specifically and individually stated to be described by reference.

In regard to the above-described embodiment, following supplementary notes are further disclosed.

### Supplementary Note 1

An analysis apparatus comprising: a support table that supports a wet-phase analysis chip having a flow passage that holds a mixed solution of a specimen sample and a reagent; a light source unit for a wet phase that emits measurement light for transmission to be transmitted through the flow passage of the wet-phase analysis chip; and an area sensor that is arranged to face the light source unit for a wet phase with the support table interposed therebetween and that captures an image showing a reaction state between the specimen sample and the reagent in the flow passage by receiving the measurement light for transmission, in which the light source unit for a wet phase includes a first light-emitting element and a second light-emitting element that emit first measurement light and second measurement light having different wavelengths, respectively, as the measurement light for transmission, in which an irradiation region of the first measurement light and an irradiation region of the second measurement light in the flow passage are present within an imaging range of the area sensor and have at least different center positions.

### Supplementary Note 2

The analysis apparatus according to supplementary note 1, in which the first light-emitting element and the second light-emitting element are arranged at an interval in a direction along the flow passage.

### Supplementary Note 3

The analysis apparatus according to supplementary note 1, in which, in a case in which a part of the irradiation region of the first measurement light and a part of the irradiation region of the second measurement light overlap each other, the first light-emitting element and the second light-emitting element are arranged at positions at which a fluctuation in a brightness value caused by the overlap of the irradiation regions in a case in which both the first light-emitting element and the second light-emitting element are turned on is 10% or less with respect to a brightness value of one irradiation region in a case in which only one of the first light-emitting element or the second light-emitting element is turned on.

### Supplementary Note 4

The analysis apparatus according to any one of supplementary notes 1 to 3, in which the first measurement light is light having a wavelength in which transmittance in a case of transmission through the specimen sample changes depending on the reaction state, the second measurement light is light having a wavelength in which transmittance in a case of transmission through the specimen sample does not change even though the reaction state changes, the analysis apparatus further comprises a processor that performs quantitative analysis of a detection target substance based on the reaction state, and the processor acquires, as the image obtained by the area sensor, an image that includes the irradiation region of the first measurement light and the irradiation region of the second measurement light and that is captured in a state in which the first light-emitting element and the second light-emitting element are turned on, and corrects a first brightness value acquired from the irradiation region of the first measurement light in the image with a second brightness value acquired from the irradiation region of the second measurement light in the image.

### Supplementary Note 5

The analysis apparatus according to any one of supplementary notes 1 to 4, in which the support table is capable of supporting a dry-phase analysis chip having a reaction region that holds a dry-phase reagent, and the analysis apparatus further comprises a light source unit for a dry phase that is arranged on an area sensor side with respect to the support table and that emits measurement light for reflection to the reaction region of the dry-phase analysis chip supported by the support table.

### Supplementary Note 6

The analysis apparatus according to supplementary note 5, in which the wet-phase analysis chip and the dry-phase analysis chip have a flat plate shape and have the same shape in plan view, the support table includes a plurality of cells in which any one of the wet-phase analysis chip or the dry-phase analysis chip is placed, the analysis apparatus further comprises a plurality of chip pressing sections that are respectively arranged to face the plurality of cells of the support table and each of which has a pressing surface for pressing the analysis chip placed on the cell, and the plurality of chip pressing sections have the same outer shape, in which the light source unit for a wet phase is arranged in at least one of the chip pressing sections and emits the first measurement light and the second measurement light from the pressing surface.

### Supplementary Note 7

The analysis apparatus according to supplementary note 5 or 6, further comprising: a processor that controls the light source unit for a wet phase, the light source unit for a dry phase, and the area sensor, in which the processor executes control of performing imaging via the area sensor with the light source unit for a wet phase turned on for the wet-phase analysis chip, and performing imaging via the area sensor with the light source unit for a dry phase turned on for the dry-phase analysis chip.

### Supplementary Note 8

The analysis apparatus according to claim 7, in which the first measurement light is light having a wavelength in which transmittance in a case of transmission through the specimen sample changes depending on the reaction state in the flow passage, the second measurement light is light having a wavelength in which transmittance in a case of transmission through the specimen sample does not change depending on the reaction state in the flow passage, and the processor acquires, as the image obtained by the area sensor, an image that includes the irradiation region of the first measurement light and the irradiation region of the second measurement light, and that is captured in a state in which the first light-emitting element and the second light-emitting element are turned on, for the wet-phase analysis chip, corrects a first brightness value acquired from the irradiation region of the first measurement light in the image with a second brightness value acquired from the irradiation region of the second measurement light in the image, and performs quantitative analysis of a detection target substance.

What is claimed is:

1. An analysis apparatus comprising:
a support table that supports a wet-phase analysis chip having a flow passage that holds a mixed solution of a specimen sample and a reagent;
a light source unit for a wet phase that emits measurement light for transmission to be transmitted through the flow passage of the wet-phase analysis chip; and
an area sensor that is arranged to face the light source unit for a wet phase with the support table interposed therebetween and that captures an image showing a reaction state between the specimen sample and the reagent in the flow passage by receiving the measurement light for transmission,
wherein the light source unit for a wet phase includes a first light-emitting element and a second light-emitting element that emit first measurement light and second measurement light having different wavelengths, respectively, as the measurement light for transmission, in which an irradiation region of the first measurement light and an irradiation region of the second measurement light in the flow passage are present within an imaging range of the area sensor and have at least different center positions.

2. The analysis apparatus according to claim 1,
wherein the first light-emitting element and the second light-emitting element are arranged at an interval in a direction along the flow passage.

3. The analysis apparatus according to claim 1,
wherein, in a case in which a part of the irradiation region of the first measurement light and a part of the irradiation region of the second measurement light overlap each other,
the first light-emitting element and the second light-emitting element are arranged at positions at which a fluctuation in a brightness value caused by the overlap of the irradiation regions in a case in which both the first light-emitting element and the second light-emitting element are turned on is 10% or less with respect to a brightness value of one irradiation region in a case in which only one of the first light-emitting element or the second light-emitting element is turned on.

4. The analysis apparatus according to claim 1,
wherein the first measurement light is light having a wavelength in which transmittance in a case of transmission through the specimen sample changes depending on the reaction state,
the second measurement light is light having a wavelength in which transmittance in a case of transmission through the specimen sample does not change even though the reaction state changes,
the analysis apparatus further comprises a processor that performs quantitative analysis of a detection target substance based on the reaction state, and
the processor
acquires, as the image obtained by the area sensor, an image that includes the irradiation region of the first measurement light and the irradiation region of the second measurement light and that is captured in a state in which the first light-emitting element and the second light-emitting element are turned on, and
corrects a first brightness value acquired from the irradiation region of the first measurement light in the image with a second brightness value acquired from the irradiation region of the second measurement light in the image.

5. The analysis apparatus according to claim 1,
wherein the support table is capable of supporting a dry-phase analysis chip having a reaction region that holds a dry-phase reagent, and
the analysis apparatus further comprises a light source unit for a dry phase that is arranged on an area sensor side with respect to the support table and that emits measurement light for reflection to the reaction region of the dry-phase analysis chip supported by the support table.

6. The analysis apparatus according to claim 5,
wherein the wet-phase analysis chip and the dry-phase analysis chip have a flat plate shape and have the same shape in plan view,
the support table includes a plurality of cells on which any one of the wet-phase analysis chip or the dry-phase analysis chip is placed,
the analysis apparatus further comprises a plurality of chip pressing sections that are respectively arranged to face the plurality of cells of the support table and each of which has a pressing surface for pressing the analysis chip placed on the cell, and
the plurality of chip pressing sections have the same outer shape, in which the light source unit for a wet phase is arranged in at least one of the chip pressing sections and emits the first measurement light and the second measurement light from the pressing surface.

7. The analysis apparatus according to claim 5, further comprising:
a processor that controls the light source unit for a wet phase, the light source unit for a dry phase, and the area sensor,
wherein the processor executes control of
performing imaging via the area sensor with the light source unit for a wet phase turned on for the wet-phase analysis chip, and
performing imaging via the area sensor with the light source unit for a dry phase turned on for the dry-phase analysis chip.

8. The analysis apparatus according to claim 7,
wherein the first measurement light is light having a wavelength in which transmittance in a case of transmission through the specimen sample changes depending on the reaction state in the flow passage,
the second measurement light is light having a wavelength in which transmittance in a case of transmission through the specimen sample does not change depending on the reaction state in the flow passage, and
the processor
acquires, as the image obtained by the area sensor, an image that includes the irradiation region of the first measurement light and the irradiation region of the second measurement light, and that is captured in a state in which the first light-emitting element and the second light-emitting element are turned on, for the wet-phase analysis chip,
corrects a first brightness value acquired from the irradiation region of the first measurement light in the image with a second brightness value acquired from the irradiation region of the second measurement light in the image, and
performs quantitative analysis of a detection target substance.
